(19) United States
(12) Patent Application Publication
(10) Pub. No.: US 2023/0096692 A1
(43) Pub. Date: Mar. 30, 2023

(54) EFFICIENT WIRELESS PUBLIC KEY EXCHANGE

(71) Applicant: Quixotic Holdings, LLC, Fife, WA (US)

(72) Inventor: Anthony Samuel Jacobs, Olney, MD (US)

(21) Appl. No.: 17/489,493

(22) Filed: Sep. 29, 2021

(51) Int. Cl. H04W 12/0431; H04W 12/03; H04W 12/041

(52) U.S. Cl. CPC H04W 12/0431; H04W 12/03; H04W 12/041

(57) ABSTRACT

A facility operating in a first mobile communication device (MCD) is described. The facility generates a key pair made up of a private key and a public key for use by the first MCD in communicating with other MCDs. The public key has information content. The facility constructs a first public key component and a second public key component, that each encode an incomplete portion of the information content of the public key; and that collectively encode the complete information content of the public key. The facility transmits a wireless message for receipt by other MCDs; it has (1) first contents that identify the wireless message as a notification signal, and (2) as second contents, the first public key component. The second contents are located at a position in the first wireless message that identifies the second contents as the node ID of the first MCD.

### BACKGROUND

Mobile communication devices such as smart phones have become an integral part of the lives of many people; the number of mobile communication devices in use continues to grow. These mobile communication devices are powerful computers that can connect via various data paths and protocols. Some of these protocols rely on the use of a different public/private key pair generated for and used by each mobile communication device.

It is typical for mobile communication devices and other wireless communication devices to exchange their public keys to enable secure communication between them. Conventionally, this occurs at the beginning of interactions between two devices: at least one of the devices periodically its availability to connect to other devices. In various scenarios, the broadcasting device may be a network access point, or may be a peer network peer. A first device includes its public key—in cleartext—in its broadcasts, along with an arbitrarily-chosen node ID. As soon as a second device receives the broadcast, the second device can begin using the first device's public key to interact with the first device, such as by encrypting communications using the first device's public key, such that these communications can only be decrypted using the first device's private key, which the first device keeps secret.

In some scenarios, the second device also broadcasts the second device's public key, which are received by the first device. In other scenarios, the second device sends its public key to the first device in a communication directed to the first device, such as a response by the second device to the first device's broadcast signal.

### BRIEF DESCRIPTION OF THE DRAWINGS

FIGS. 1A-1B illustrate context diagrams of an environment for establishing an ad hoc mesh network in accordance with embodiments described herein.

FIGS. 2A-2B illustrate block diagrams of the different layers of the ad hoc mesh network in accordance with embodiments described herein.

FIG. 3 illustrates an example participant table 120 that tracks participants in the cognitive heterogeneous ad hoc mesh network in accordance with embodiments described herein.

FIG. 4 illustrates a logical flow diagram showing one embodiment of an overview process for a mobile participant to transmit and receive notification signals to manage the participant table of a cognitive heterogeneous ad hoc mesh network in accordance with embodiments described herein.

FIG. 5 is a data flow diagram showing how a node public key is changed in some embodiments as part of its transfer by the facility.

FIG. 6 is a data flow diagram showing a typical exchange of messages by which the facility transfers a node public key in some embodiments.

FIG. 7 is a flow diagram showing a process performed by the facility in some embodiments in a transferor node to send a first portion of the transferor node's public key data to one or more transferee nodes.

FIG. 8 is a flow diagram showing a process performed by the facility in some embodiments in a transferee node to receive a first portion of a transferor node's public key data.

FIG. 9 is a flow diagram showing a process performed by the facility in some embodiments in the transferor node to send a second portion of the transferor node's public key data to the transferee.

FIG. 10 is a flow diagram showing a process performed by the facility in some embodiments in the transferee node to receive a second portion of the transferor node's public key data and reconstitute the transferor node's public key.

FIG. 11 shows a system diagram that describes one implementation of computing systems for implementing embodiments described herein.

FIG. 12 shows a system diagram that describes another implementation of computing systems for implementing embodiments described herein.

### DETAILED DESCRIPTION

The inventors have identified disadvantages in the conventional approach to exchanging public keys between mobile communication devices described above. First, the inventors have recognized that sending the entire public key in a single communication limits the size of the public key, based upon constraints on the size of that communication, such as a maximum transmission unit size specified in a communication protocol used to send the communication. For example, in certain communication protocols, the amount of space available for the public key is limited to 128 bits. The smaller the public key is, the less security it offers.

Second, the inventors have recognized that the conventional approach makes inefficient use of the space in notification messages by allocating some of it to the broadcasting node's arbitrary node ID.

Third, the inventors have recognized that, in the conventional approach, any node capable of receiving a broadcasting device's notification signal can extract the enclosed cleartext public key for the broadcasting device and immediately begin communicating with the broadcasting device, potentially in a malicious manner, or one that is wasteful of the broadcasting device's resources.

In response to recognizing these disadvantages of conventional public key exchanges between wireless communication devices, the inventors have conceived and reduced to practice a software and/or hardware facility (“the facility”) for operating wireless networks in which wireless devices (“network nodes,” or “nodes”) exchange public keys by constructing each node's node ID using part of the data in that node's public key. Thus, a first node broadcasting a notification signal sends a first portion of the data in the first node's public key (“portion a,” or “a”) as the first node's node ID in the notification signal. That is, the notification signal contains portion a in its sender node ID field, and does not contain any other node ID for the first node. When a second node responds to the first node's notification signal with a request to connect, the first node sends a directed communication to the second node containing the remaining data in the first node's public key (“portion b,” or “b”). These two portions are sometimes called “public key components” or “public key token components” herein. The second node reconstitutes the first node's public key from the two portions of the first node's public key contained by the two communications received by the second node from the first node. In this way, the facility is able to use larger and more secure public and private keys than the conventional approach, and does not incur the data transfer cost of a node ID for the first node that is arbitrary and not related to the first node's public key. In some embodiments, the facility proceeds in a similar way to transfer of the second node's public key to the first node. At some points herein, a node that is transferring its public key is referred to as the “transferor node,” or “transferor;” a node to which a public key is being transferred is referred to as the “transferee node,” or “transferee.” Many nodes operate both as transferor nodes and transferee nodes.

In various embodiments, the facility is implemented as software and/or hardware installed and operating in participants, such as software and/or hardware that manages one or more ad hoc mesh networks; in some embodiments, aspects of the facility that support one or more ad hoc mesh networks are installed and operate in computing systems other than network participants. In various embodiments, the mesh networks operated by the facility are wireless networks, line-of-sight networks of other types, or wired or guided networks.

In some embodiments, the facility transforms the data about the public key being transferred to secure or obfuscate it. In this transformation, the facility uses a process and/or data that are known to both the transferor node and the transferee node. In some embodiments, this process and/or data are stored in all the nodes authorized to participate in the network. For example, in some embodiments, before splitting the transferor public key into a and b, the facility transforms the transferor public key by rotating it by a fixed number of bits known to the transferor and the transferee, and possibly some or all of the other nodes that are authorized to participate in the network. In some embodiments, rather than using a fixed number of bits for the rotation, the facility uses a variable number of bits determined from current date and time using a formula known to at least the transferor and transferee. In such embodiments, in the transferee, the facility uses the information known to at least the transferor and transferee to reverse the transformation by reversing the rotation. In some embodiments, the facility transforms the transferor public key by encrypting it using a symmetric key or a public/private key pair known to at least the transferor and transferee. In such embodiments, in the transferee, the facility reverses the transformation by using the symmetric key or the opposite key of the key pair to decrypt the transferred data. In some embodiments, the facility transforms the transferor public key by applying the elliptic curve digital signature algorithm (“ECDSA”) to use the transferor public key to generate a signature for a fixed message that is known to at least the transferor and transferee. In such embodiments, in the transferee, the facility reverses the transformation by applying an ECDSA public key recovery process to the combination of the signature and the fixed message. By transforming the transferor public key in any of these ways, the facility makes it more difficult for nodes that are not authorized to participate in the network—and therefore do not possess the information needed to reverse the transformation—to obtain and use the transferor public key. This facility permits limited access to the network and the ability to quickly identify malicious players on the network. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with less latency, and/or preserving more of the conserved resources for use in performing other tasks or additional instances of the same task. For example, the facility conserves data transmission resources among network nodes that would be required to transfer public keys separately from arbitrary node IDs. Also, the facility conserves processing resources that would be used in nodes authorized to participate in the network to process requests from nodes not authorized to participant in the network that rely on ready access to the authorized nodes' public keys in plaintext.

In some embodiments, the facility operates in wireless mesh networks, or wireless ad hoc networks—in which wireless communication devices (“communication devices,” “network participants, “mobile participants,” or “participants”) communicate directly with one another without relying on centralized management of the network.

As referred to herein, a “participant” is an object that includes a computing device that can communicate specific, predetermined types of information and data to other participant objects via wireless or other communications means. In some embodiments, each participant may be a member of a universal service-level agreement to identify which objects are participants, which allows for participants to communicate with one another without having to get user authorization for each individual connection between participants.

As discussed in more detail herein, participants can be mobile or stationary and may include computing devices of different sizes having different computing or networking capabilities. Throughout this disclosure, the term “participant” is used interchangeably with “participant object” and “participant computing device” and “node” and other related variations, and the term “non-participant” is used interchangeably with “non-participant object” and other related variations.

As referred to herein, “line-of-sight communication” refers to wireless or wired transmission of information from a participant to another participant without other retransmission devices. A line-of-sight communication may also be referred to as a single hop from one participant to another participant or a direct communication between participants. Accordingly, line-of-sight is the maximum range one participant can communicate wirelessly with another participant without significant data loss. Examples of wireless transmissions used in line-of-sight communications include Bluetooth, Wi-Fi, ADSB, TCAS, or other protocols now known or developed in the future. In some embodiments, all communications between participants utilize a common protocol.

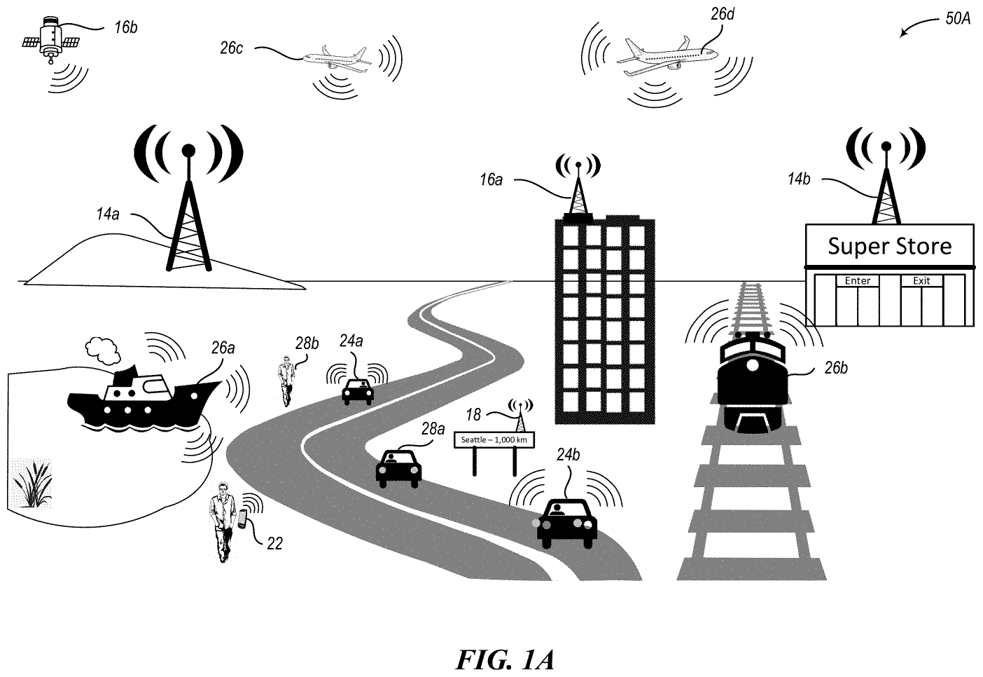

FIGS. 1A-1B illustrate context diagrams of an environment for establishing an ad hoc mesh network in accordance with embodiments described herein. In various embodiments, the facility may implement some or all embodiments described herein with respect to generating and maintaining the ad hoc mesh network. Environment 50A in FIG. 1A includes a plurality of mobile participants (referenced in some figures as mobile participants 36), a plurality of stationary participants (referenced in other figures as stationary participants 34), and a plurality of non-participants 28a-28b. As mentioned above, the stationary participants and the mobile participants can communicate specific types of information or data with one another, but cannot communicate the same types of information with the non-participants 28a-28b.

The plurality of mobile participants includes tier 1 mobile participants 22, tier 2 mobile participants 24, and tier 3 mobile participants 26. The three tiers of mobile participants are generally separated by the computing and networking capabilities of the computing devices associated with the mobile participant. The computing and networking capabilities may be limited or determined by the amount of power available or utilized by a mobile computing device, the amount of processing power available, the size or type or accuracy of the antenna utilized, etc.

For example, tier 1 mobile participants typically have the smallest available power, lowest processing power, lowest bandwidth, shortest ranged antenna, lowest power output, lowest accuracy, and slowest update rate. Examples of tier 1 mobile participants include, but are not limited to, mobile phones, laptop computers, tablet computers, wearable computing devices, or other smaller, low power, low transmission mobile computing or Internet-Of-Things devices. In the example illustrated in FIG. 1A, there is only a single tier 1 mobile participant 22, which happens to be a mobile phone in this example. However, other numbers and types of tier 1 mobile participants may also be employed.

Tier 2 mobile participants typically have medium power constraints, a medium amount of processing power, medium bandwidth, medium range capabilities, medium accuracy, and medium update rate. Examples of tier 2 mobile participants include, but are not limited to, automobiles, small personal boats, personal aircrafts, or other medium power, medium transmission, power regenerating mobile computing devices or objects that can support such mobile computing devices. FIG. 1A illustrates example tier 2 mobile participants as including automobiles 24a and 24b. However, other numbers and types of tier 2 mobile participants may also be employed.

Tier 3 mobile participants typically have the largest available power, highest processing power, highest bandwidth, longest transmit and receive capabilities, highest accuracy, and fastest update rate among mobile participant computing devices. Example tier 3 mobile participants include, but are not limited to, commercial airline planes, semi-trucks, cargo ships, trains, or other objects that can support larger, high power, high transmission mobile computing devices or objects that can support such mobile computing devices. FIG. 1A illustrates example tier 3 mobile participants as including boat 26a, train 26b, and airplanes 26c and 26d. However, other numbers and types of tier 3 mobile participants may also be employed.

Various embodiments described herein refer to mobile aerial participants or mobile ground participants. Mobile aerial participants and mobile ground participants are mobile participants. Thus, mobile aerial participants and mobile ground participants may likewise be separated into the three-tiers of participant capabilities.

For example, tier 1 mobile aerial participants may include personal computing devices that are onboard an airplane, such as user devices; tier 2 mobile aerial participants may include general aviation aircraft; and tier 3 mobile aerial participants may include cargo aircraft and commercial aircraft. Tier 1 mobile ground participants may include personal computing devices that are on a person walking down the street or on a car or in a boat; tier 2 mobile ground participants may include automobiles or recreational watercraft; and tier 3 mobile ground participants may include semi-trucks and cargo ships.

In some embodiments, one or more of these tiers may be further separated by capabilities or expected utilization. For example, tier 3 mobile aerial participants may include tier 3A mobile aerial participants that include cargo aircraft and tier 3B mobile aerial participants that include commercial aircraft. One situation where this distinction may occur is where a commercial aircraft is handling a lot of data requests from user devices onboard the aircraft (e.g., tier 1 mobile aerial participants), which may impact that aircraft's throughput for forwarding communications between other participants. Conversely, a cargo aircraft is typically not handling a lot of data request from user devices onboard the aircraft, but is instead primarily being used to forward communications between other participants.

Although some embodiments may be described herein with respect to mobile aerial participants, embodiments are not so limited. Those same embodiments may instead utilize mobile ground participants or a combination of mobile ground participants and mobile aerial participants, unless the context clearly indicates otherwise.

The plurality of stationary participants includes ground entry points 14, remote entry points 16, and access nodes 18. In some embodiments, stationary participants may be referred to as ground participants. Similar to the three tiers of mobile participants, the ground entry points 14, remote entry points 16, and access nodes 18 are generally separated by computing and networking capabilities, and footprint size in some embodiments.

For example, ground entry points 14 typically have the largest available power, highest processing power, highest bandwidth, and longest range antenna capabilities. Example locations of ground entry points 14 include, but are not limited to, cellular towers, airports, large retail or superstores, or other locations that can support large sized, high power, high transmission stationary computing devices. FIG. 1A illustrates example ground entry points 14 as including tower antenna 14a and superstore 14b. However, other numbers and types of ground entry points 14 may also be employed.

Remote entry points 16 typically have medium power constraints, a medium amount of processing power, medium bandwidth, and medium range capabilities. Example locations of remote entry points 16 include, but are not limited to, restaurants and coffee shops, airfields and train stations, satellites, or other locations that can support medium sized, medium power, medium transmission stationary computing devices. FIG. 1A illustrates example remote entry points 16 as including store antenna 16a and satellite 16b. However, other numbers and types of remote entry points 16 may also be employed.

Access nodes 18 typically have the smallest available power, lowest processing power, lowest bandwidth, and shortest range antenna capabilities of the stationary participants. Example locations of access nodes 18 include, but are not limited to, road intersections, train crossings, road signs, mile markers, crosswalks, or other locations that can support smaller, low power, low transmission stationary computing devices. In the example illustrated in FIG. 1A, there is only a single access node 18, which happens to be a road sign in this example. However, other numbers and types of access nodes 18 may also be employed.

As described in greater detail below, the mobile and stationary participants communicate with one another to pass information from one participant to another, which is further illustrated in FIG. 1B.

Environment 50B in FIG. 1B provides additional details regarding environment 50A in FIG. 1A, and likewise includes a plurality of mobile participants, a plurality of stationary participants, and a plurality of non-participants. Participants can communicate with other participants or with non-participants by forwarding communications between participants. Each participant utilizes a locally stored participant table to determine a next participant in which to send communications along an optimum route between the sending participant and the destination device, which is described in more detail below.

Briefly, however, in this example, participant airplane 26c is attempting to communicate with participant train 26b. If participant airplane 26c is within line-of-sight of train 26b, then the two participants could communicate directly with one another. But if airplane 26c cannot directly communicate with train 26b, then airplane 26c will communicate with train 26b via other participants.

Airplane 26c utilizes a participant table to identify one or more routes from airplane 26c to train 26b via zero, one, or a plurality of other participants. Creation and update of the participant table is discussed in more detail below.

In some embodiments, each participant that forwards a communication message may modify the additional route information to remove route information for previous participants along the route, which allows subsequent participants to transmit less and less data for each hop along the route. In other embodiments, the additional route information is maintained so that the destination participant knows the route of the messages and can reuse the same route to transmit return messages to the originally sending participant, or the destination can recalculate a new route.

In some embodiments, a participant along the route may determine that it should re-calculate a route from that participant to the destination participant. In one embodiment, this determination may be based on the participant not being able to transmit messages to the next participant identified in the additional route information included with the messages, such as if the participant and the identified next participant are no longer in line-of-sight communication with one another. In another embodiment, the participant may re-calculate the route if the connection between the participant and the next participant has significantly deteriorated, e.g., the individual score between that corresponding participant pair has exceeded a threshold value. In one example, the individual score may change based on a system limitation of the participant or the next participant, such as if Doppler effects between the participant and the next participant exceeds a threshold value based on the antenna capabilities of the participant and the next participant. For the illustrated example, tower 14a may perform similar actions as airplane 26c by using the participant table to determine a next participant in which to forward the messages destined to train 26b.

In these examples, the communication links 25, 27, 29, and 31 are line-of-sight communication transmissions from one participant computing device to another. As described elsewhere herein, these transmissions may be non-directional transmissions or they may be directional transmissions.

Even though FIGS. 1A and 1B are illustrated with stationary participants, the line-of-sight communications described herein enables mobile participants to communicate with one another without having to be in line-of-sight communication of a stationary participant, which reduces the need for a complex stationary infrastructure. Moreover, embodiments described herein enable mobile participants to communicate with one another even if the stationary participants become unavailable or if wired communication networks between stationary participants become interrupted. Moreover, the stationary participants can communicate with other participants without the need for specialty hardware for different cellular carriers or networks, rather it can rely on common line-of-sight wireless protocols, such as Wi-Fi technology under the IEEE 802.11 standards, as well as ad hoc protocols now known or developed in the future.

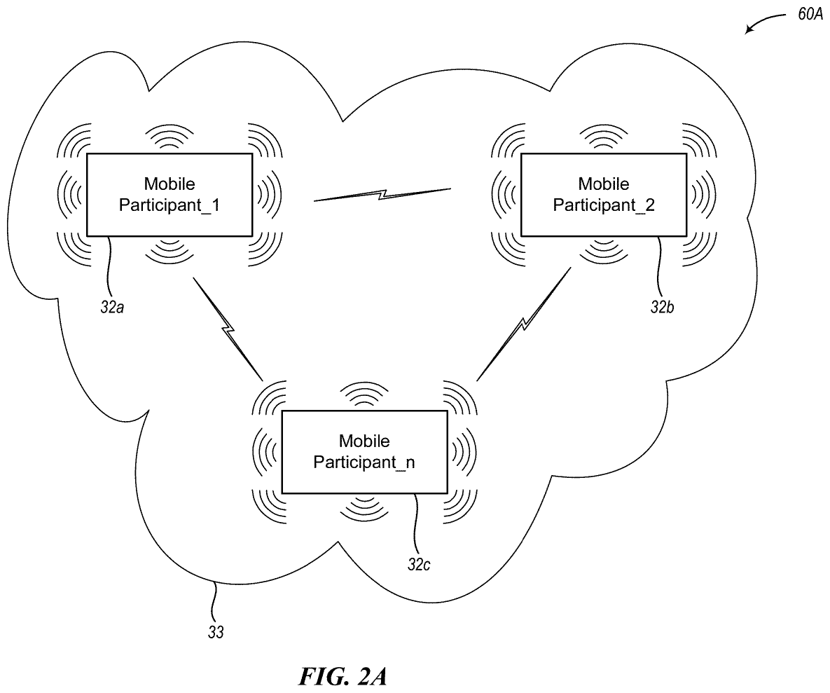

As mentioned above, each participant can select another participant through which it can forward communication messages based on a participant table. The participant table identifies each participant, where each participant is located, how each participant is moving, which participants are within line-of-sight of each other, and various different characteristics or communication capabilities between line-of-sight participants. Creating, updating, and using the participant table is described below, and one example participant table is illustrated in FIG. 3.

The overarching ad hoc mesh network created by the mobile and stationary participants described above in conjunction with FIGS. 1A-1B provides a backbone for a multi-layered network that enables one participant to communicate with another participant, while also providing safety measures to avoid collisions among participants and non-participants.

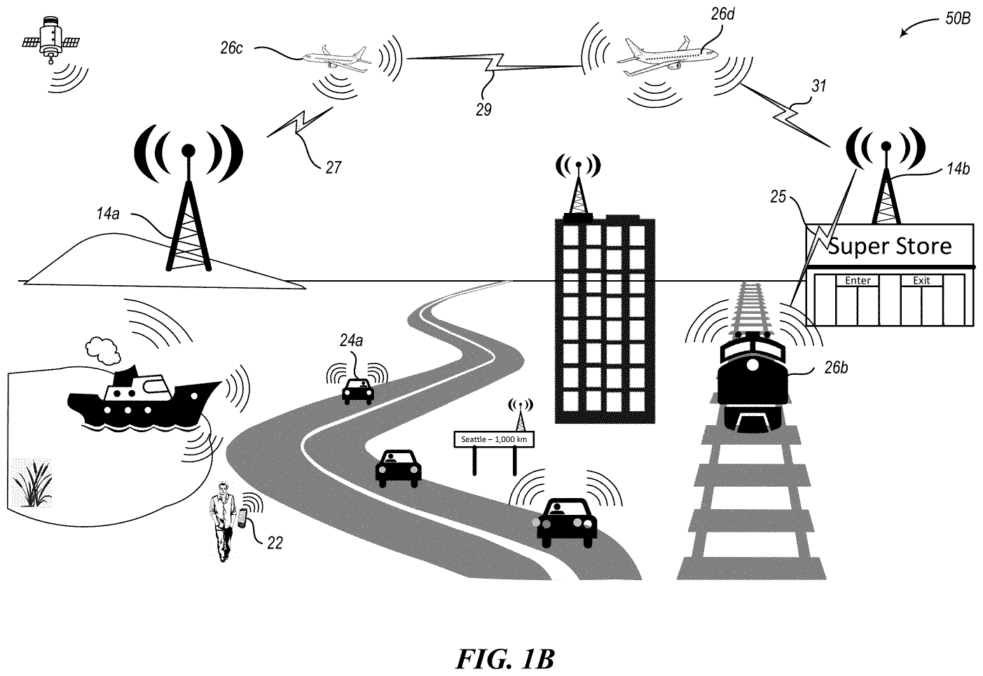

FIGS. 2A-2B illustrate block diagrams of the different layers of the ad hoc mesh network in accordance with embodiments described herein. FIG. 2A illustrates an example 60A of a communications network 33 between a plurality of mobile participants 32a-32c. Although FIG. 2A only illustrates three mobile participants as creating network 33, embodiments are not so limited and one or a plurality of mobile participants may be employed. Similarly, the network 33 may be established from other types of mobile participants, including various combinations of tier 1 mobile participants, tier 2 mobile participants, or tier 3 mobile participants, which perform many of the same functions as the mobile participants.

Each mobile participant 32a-32c transmits radio frequency signals to be received by other mobile participants 32 that are within line-of-sight of the sending mobile participant 32. These signals include, but are not limited to (1) data signals that transmit messages or data to another participant and (2) notification signals that provide personalized information regarding the sending mobile participant. In some embodiments, the notification signals are referred to as self-reporting messages or self-reporting signals. The notification signals can include one or both of notification signals for networking and routing among participants and notification signals for safety and de-confliction of possible threats.

The notification signals serve three primary simultaneous purposes: (1) to notify other participants of the sending participant's identity, position, and kinematic information; (2) to detect and track non-participant objects; and (3) to establish routing and network efficiencies (i.e., to create the participant table described herein). In various embodiments, the notification signals provide individualized information regarding the sending mobile participant 32 so that other mobile participants 32 know that they are within line-of-sight communication of the sending mobile participant 32 within network 33. As mentioned above, these notification signals may be referred to as self-reporting signals, since the mobile participant 32 is independently reporting its position and kinematic information to any other mobile participants 32 that are within line-of-sight of the transmitting mobile participant 32 without being prompted or requested by another mobile (or stationary) participant. The mobile participants 32 utilize the notification signals to generate a participant table that is utilized to transmit data signals between the mobile participants 32.

In various embodiments, the information in the notification signal includes the mobile participant's 32 identification information, geolocation, kinematic information, throughput capabilities, frequency capabilities, and other information. In various embodiments, the notification signals also include transmission time information that allows for Time Distance of Arrival (TDOA) and Time of Flight (TOF) or Round Trip Timing (RTT) calculations.

The geolocation of the mobile participant 32 may be determined via traditional methods like GPS sensors or modules, cell tower or stationary participant signal triangulation, or via notification messages from other devices or participants that know or estimate the position or location of the mobile participant 32. This can be accomplished with extreme accuracy and minimal latency when notification messages are echoed and supported by stationary participants. The geolocation may also be referred to as the position or location of the mobile participant 32.

The kinematic information may be obtained by monitoring the mobile participant's 32 position and identifying changes over time, utilizing various sensors to calculate or determine the kinematic information, or obtaining it from another system.

The frequency capabilities of the mobile participant 32 may be predetermined based on the type of hardware utilized by the mobile participant 32. For example, the hardware of the mobile participant 32 may be designed to utilize ACARS, IEEE 802.11 standards, or some other wireless transmission frequencies or standards, which defines the frequency capabilities of the mobile participant 32. In other embodiments, the frequency capabilities may be predetermined based on government regulations regarding available frequencies. In yet other embodiments, the frequency capabilities may be defined by a user or administrator.

The throughput may be predetermined based on the type of hardware utilized by the mobile participant 32 or on the current processing capacity or network traffic of the mobile participant 32 or a number of other factors. For example, if the mobile participant 32 is a Boeing 737-700 then it may have more throughput capabilities than a Boeing 777-200ER because the Boeing 737-700 may have less passengers and thus may be supporting fewer data requests from user device onboard the airplane, which can allow for more possessing power to be directed towards forwarding communications between other participants.

In some embodiments, notification signals are transmitted via directional broadcast beams. In other embodiments, the notification signals may be transmitted using non-directional broadcast signals. In general, the use of the term “broadcast” herein refers to the transmission of a signal by a sending participant without being requested by another participant and does not have a specific participant as a destination. In various embodiments, directional notification signals may be transmitted in a sequential or non-sequential 360-degree pattern, so that the notification signal is transmitting in all directions surrounding the participant.

Use of directional transmissions can reduce the amount of power needed to transmit the notification signal or other communication to another participant. Moreover, the use of directional transmissions enables the sending participant to use just enough power to ensure it gets to its intended target. The participant table described herein enables the participants to calculate the required transmit power for transmission without wasting extra power on an overly powerful transmission. Additionally, directional transmissions can reduce interference between transmissions in a congested space as well as make transmissions more secure.

The notification signal may be broadcast periodically, at predetermined times, dynamically selected based on number and proximity of other mobile participants, or at a given dynamically changing update rate. In some embodiments, the rate at which the mobile participant 32 transmits its notification signal may change based on a combination of the distance, closure velocity, and closing angles between the sending mobile participant 32 and other mobile participants 32 within line-of-sight of the sending mobile participant 32.

As mentioned above, the mobile participants 32a-32c broadcast notification signals to inform other mobile participants 32 of their position and movement. For example, mobile participant 32a broadcasts notification signals with information identifying itself and its respective geolocation and kinematic information without regard to the presence or location of mobile participants 32b or 32c. If mobile participant 32c is within line-of-sight of mobile participant 32a, mobile participant 32c receives the broadcasted notification signals from mobile participant 32a and utilizes the information in the notification signals, and its own location and kinematic information, to identify the position and movement of mobile participant 32a relative to itself.

The mobile participants 32 can utilize the notification signals to track other participants and to create and update the participant table to identify which participants are in network 33, their location, their capabilities, and who they are in line-of-sight communication.

As mentioned above, the notification signals are utilized to generate and maintain a participant table so that the mobile participants 32 can transmit messages or data to one another within network 33. For example, the participant table is utilized to determine a recipient participant. The sending mobile participant 32 then transmits a data signal destined for a target mobile participant 32. The data signals are used to transmit the desired messages or data to other participants, which is described in more detail below in conjunction with FIG. 2B. Briefly, the various communications between the mobile participants 32a-32c creates a communication network 33 among each other that enable them to communicate with one another without the use of another communication backbone, such as a cellular tower network.

Similar to the notification signals, the data signals may be transmitted via directional transmission beams or non-directional transmission signals. In various embodiments, the sending mobile participant 32 utilizes the participant table to determine a location of the recipient participant. The sending mobile participant 32 can directionally focus the transmitted data signals towards the recipient participant based on the position of the sending participant and the position of the recipient participant. The use of directional transmissions can reduce power consumption and increase the range in which transmission can be received, while also reducing interference between transmissions in a congested space.

Although not illustrated, other mobile participants and stationary participants may also perform similar actions as described above to identify and track mobile participants that are in line-of-sight to support management of the participant table and to communicate data or information amongst themselves to increase accuracy and efficiency of each participant.

The messages or information contained in the data transmissions may have originated by the sending participant or it may have originated by another computing device and is now being forwarded by the sending participant. In some embodiments, the data may originate at one participant and be destined for another participant. In other embodiments, the data may originate at a non-participant computing device (e.g., content servers, web servers, remote networks, etc.) and be destined for a participant. In yet other embodiments, the data may originate at one participant and be destined for a non-participant computing device.

If the sending participant is within line-of-sight to a destination participant, then the originating participant sends the message or data directly to the destination participant. But if the sending participant is not within line-of-sight to the destination computing device, then the sending participant transmits the message or data to another participant who can continue to forward the message or data toward the destination computing device, which may include one or more “hops” between mobile or stationary participants.

In some embodiments, the data signals may be transmitted whenever the participant has data to be sent and has bandwidth or computing power to transmit the data. In other embodiments, the data may be buffered for a period of time until it can be successfully transmitted from the sending participant to another mobile or stationary participant.

In various embodiments, the participants may use one of various different frequencies to transmit data signals to other participants. In some embodiments, participants scan the entire spectrum or spectrums they are physically able, and legally allowed, to transmit within. Each participant determines based on real-time and historical data what frequencies are available and the length of transmission that can be transmitted without interference on each frequency, as well as what transmitters are available on the participant. In some embodiments, the participants may utilize Dynamic Spectrum Access (DSA) to use multiple frequencies for a single transmission to make full use of the available spectrum. Participants can “sniff” the spectrum and identify free space to use and make such information available to other participants via the participant table. For example, if an airplane is in a thunderstorm it can identify and avoid those frequencies that are unusable for use in unstable whether, and it knows what participants are within range and what frequencies they have available to retransmit to a stationary participant, if required. From this information in the participant table, the aircraft can choose the appropriate frequency/frequencies to transmit on to obtain the highest data-rate while maintaining a signal to noise ratio that ensures data packet reception.

In various embodiments, each participant determines a Quality of Service (QOS) and Signal to Noise Ratio (SNR) between it and each other participant in line-of-sight of that participant, as well as available frequencies to the receiving participant. The participant then assesses the data it needs to transfer and chooses the most efficient frequency with a high QOS and SNR on which to transmit. Moreover, participants may utilize additional information to select what frequencies to transmit data. For example, if a participant is in a thunderstorm, it selects frequencies that are more suitable for use in inclement weather.

The participant can cross reference the throughput and frequency abilities of the other participants, via the participant table, to determine the path and frequency on which to send the data. Once that is determined, the participant can route the data and amplify the signal based on the frequency, distance or latency to the chosen participant, and any known interference values it may have.

In some embodiments, each participant utilizes protocols to establish transmit priorities based on the participant's role at any given moment. For example, an aircraft prioritizes safety of flight information first, then ATC communications, navigation, identification, headquarter communication, then Internet/entertainment connectivity. A cell phone, depending on environment, may act in different ways. For example, at home, it may prioritize Wi-Fi frequencies and prioritize voice communications, then text, then Internet, then email. However, when the cell phone is in a car traveling down the road, the cell phone can use its gyrometers and accelerometers to detect that you are in a vehicle and set the priorities for V2X (vehicle to vehicle/Infrastructure/Pedestrians/other transportation) above voice, text and Internet data exchanges. In contrast, if the cell phone is in a bus or train it may not transmit V2X information.

As mentioned above with respect to FIG. 2A, the multi-layered network allows each participant to track other participants that are local or proximal to the participant, while also tracking transmitted data among participants. The multi-layered network also includes a top layer that provides global tracking of participants and non-participants, and data communication with non-participant computing devices, which is illustrated in FIG. 2B.

FIG. 2B illustrates a block diagram of the highest layer of the multi-layered network. Example 60C in FIG. 2B includes mobile participants 36, stationary participants 34, and network operation center server 40.

Mobile participants 36 and stationary participants 34 employ embodiments described herein to transmit notification signals to generate a participant table to track participants, their location, and the communication characteristics between line-of-sight participants. In various embodiments each stationary participant 34 stores a complete copy of the participant table. When a stationary participant 34 receives an update to the participant table from a mobile participant 36, the stationary participant 34 transmits the update to the other stationary participants 34. The stationary participants 34 also transmit, upon receipt of an update or at predetermined times, the total participant table or only a portion thereof to the mobile participants 36 that are in line-of-sight communication of that corresponding stationary participant 34, which can then be forwarded by the mobile participants 36 to other non-line-of-sight mobile participants 36.

In some other embodiments, the stationary participants 34 may maintain or store a portion, but not all, of the total participant table. For example, each stationary participant 34 stores the portion of the participant table for mobile participants 36 that are within a predetermined distance or number of hops away from the corresponding stationary participant 34. In at least one such embodiment, the stationary participants 34 may provide updates to the network operation center server 40 via communication network 52, which can then distribute the update, i.e., only the update, the total participant table, or a portion of the participant table, to other stationary participants 34. In some embodiments, the network operation center server 40 or the stationary participants 34 can add additional information to the participant table, such as the location of non-participants, which may be obtained from FAA reports, weather radar, local tracking by the mobile participants 36 or the stationary participants 34, or other sources.

As discussed herein, mobile participants 36 utilize the participant table to transmit or forward data or data requests to other mobile participants 36 or to non-participant computing devices 54. Accordingly, the mobile participants 36 communicate with stationary participants 34 (either via line-of-sight communications or via one or more other mobile participants 36) to send and receive data to and from the non-participant computing devices 54 via communication network 52.

The communication network 52 may be any wired or wireless communication network that facilitates the transmission of information from stationary participants 34 to network operation center server 40. In some embodiments, communication network 52 may be the Internet.

In various embodiments, the mobile participants 36 may also provide additional information to the stationary participants 34 and to the network operation center server 40. For example, in some embodiments, the mobile participants 36 may utilize echo signals from the notification signals to track non-participant objects 38, which is described in more detail in U.S. patent application Ser. No. 15/892,259, filed Feb. 8, 2018, entitled “Object Tracking Using A Cognitive Heterogeneous Ad Hoc Mesh Network.”

FIG. 3 illustrates an example participant table 120 that tracks participants in the cognitive heterogeneous ad hoc mesh network in accordance with embodiments described herein. Participant table 120 includes individual participant information 122 and line-of-sight participant information 124.

The individual participant information 122 separately identifies multiple participants 126a-126b. For each participant 126a-126b, the individual participant information 122 includes an identifier 128 for the corresponding participant 126a-126b, and kinematic information 130 of the corresponding participant 126a-126b which can include location information of the corresponding participant 126a-126b. Spectrum capabilities 131 of the corresponding participant 126a-126b describe the available media types associated with this node. Also included is a timestamp 132 indicating the time at which the information for the corresponding participant 126a-126b was determined or updated, and a public key 133 determined by the participant computing this table 120 for the peer participant 126a-126b. The individual participant information 122 may also include other information, not shown, such as radio or processing capabilities of the corresponding participant, security protocols or encryption information, system limitations, or other information.

The line-of-sight participant information 124 lists those participants that are within line-of-sight communication of participants 126a-126b, which establishes each participant pair in the participant table 120. For example, corresponding line-of-sight participants 148a-148b are in line of sight of participant 126a.

The line-of-sight participant information 124 includes an identifier 134 for each corresponding line-of-sight participant 148a-148d, a quality of signal 136 for the notification signal sent by the corresponding line-of-sight participant 148a-148d that was received by the corresponding participant 126a-126b, frequency capability 138 and spectrum 140 capabilities of each corresponding line-of-sight participant 148a-148d, and a public key 141 determined by the participant computing this table 120 for each of the other line-of-sight participant.

In some embodiments, the line-of-sight participant information 124 also includes the weighted value 144 between each corresponding participant pair. The weighted value 144 is the individual score for that corresponding participant pair, which is based on a weighted combination of the latency in transmissions between the pair participants, movement of the participants relative to one another (e.g., based on the difference between the kinematic information 130 of each participant in the pair), quality of signal 136 between the pair participants, frequency 138 and spectrum 140 capabilities between the pair participants (e.g., based on the spectrum capabilities 131), whether the timestamp 132 is beyond some threshold amount of time in the past, other information, or any combination thereof. Distance may be a factor of latency because a total latency of a transmission is based on a processing time to transmit a communication, a flight time of the transmission (based on the distance between the participants and the speed at which radio waves propagate through the air), and a processing time to receive the communication.

Each of these types of information may be provided an initial score (e.g., if two airplanes are within 200 meters of each other then it may have a better, lower score than two airplanes 2 kilometers apart), which may be based on one or more thresholds or may be actual values. Each type of information is then weighted based on various factors that can impact the communication between the participant pairs. For example, in some situations, quality of signal may be more important and weighted higher than latency, but kinematic information may be more important and weighted higher than quality of signal (e.g., due to the potential data loss issues from Doppler effect or the potential to be out of line-of-sight). Thus, each type of information may be weighted based on its importance relative to the other types of information such that more important information has a higher weight than lower important information.

In at least one embodiment, the individual score between a participant pair may be based on system limitations of one or both of the participants in the participant pair. For example, participant antennas can generally account for some amount of Doppler shift/effects. However, if the participants of a participant pair are traveling towards one another at a high enough rate of speed, then the antennas may not be able to account for the Doppler shift/effects, which may result in a reduction of quality of service, throughput, or dropped information. Such system limitations may impact the individual score, which can result in calculating a route to avoid participant pairs that currently have or may have system limitations. In at least one such embodiment, one or more thresholds may be employed such that as the Doppler shift/effect becomes worse, the individual score also gets worse (e.g., increases).

In some embodiments, system limitations may be included in the participant table or may be deduced from information within the participant table. In other embodiments, some of these system limitations may not be included in the participant table or may change based on movement of the participants, which can result in increased latency or re-routing the communication.

In various embodiments, each corresponding participant 126 updates its locally stored version of the participant table 120. Stationary participants can update the participant table 120 maintained by the stationary participants based on the information contained in the notification signal sent by the participants 126.

While FIG. 3 shows a table whose contents and organization are designed to make it more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

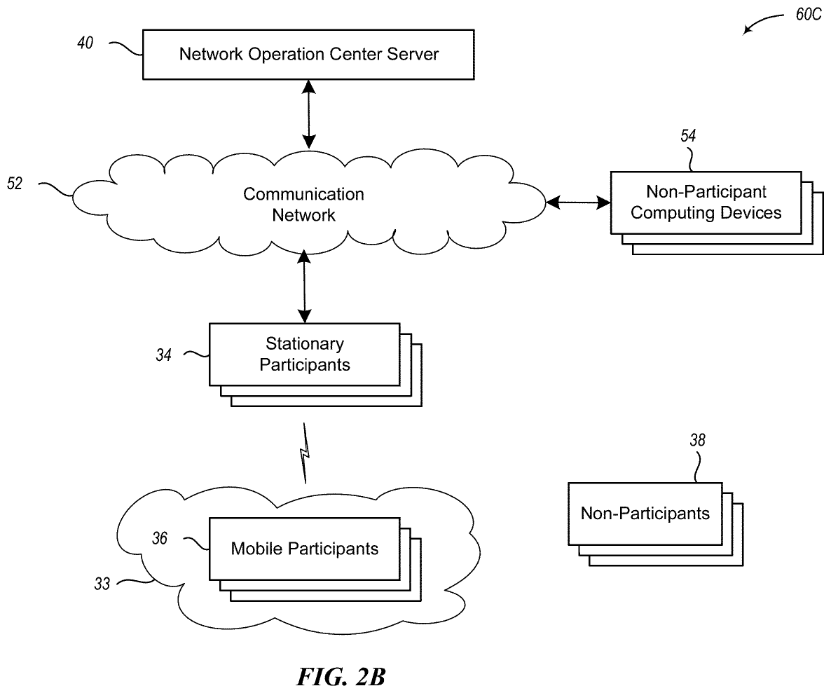

The operation of certain aspects will now be described with respect to FIG. 4. In at least one of various embodiments, process 150 described in conjunction with FIG. 4 may be implemented by or executed on one or more computing devices, such as mobile participants 36 or stationary participants 34.

FIG. 4 illustrates a logical flow diagram showing one embodiment of an overview process for a mobile participant to transmit and receive notification signals to manage the participant table of a cognitive heterogeneous ad hoc mesh network in accordance with embodiments described herein.

Process 150 begins at act 152, where a first mobile participant transmits a notification signal. In various embodiments, the first participant transmits the notification signal at a predetermined rate, periodically, at predetermined times, or based on various operating characteristics of the first participant. The rate at which notification signals are transmitted may be static or dynamic and may change based on the distance and rate of closure between other participants or the number of other participants within line-of-sight of the first participant.

Process 150 proceeds to decision act 154, where the first participant receives a notification signal from a second participant. In various embodiments, the first participant may process each notification signal sent by the second participant and received by the first participant. In other embodiments, the first participant may process a subset of the notification signals received from the second participant. If the first participant has received a notification signal from the second participant and the first participant is to process the notification signal, then process 150 flows to act 156; otherwise process 150 returns to act 152 to continue sending its notification signals and waiting for notification signal from other participants.

At act 156, the first participant updates its local version of the participant table based on the information in the received notification signal from the second participant. If the second participant is not in the participant table as being within line-of-sight communication of the first participant, the first participant adds the second participant to the participant table indicating that the first and second participants are within line-of-sight communication of one another, as a participant pair. If the second participant is already listed in the participant table, the first participant updates the participant table with the information from the received notification signal, such as the current location and kinematic information from the second participant. In some embodiments, the first participant updates the participant table to include additional information regarding the communication with the second participant, such as the quality of signal received from the second participant, signal to noise ratio, frequency or spectrum capabilities, etc. After act 156, the first participant continues in act 152.

Those skilled in the art will appreciate that the acts shown in FIG. 4 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

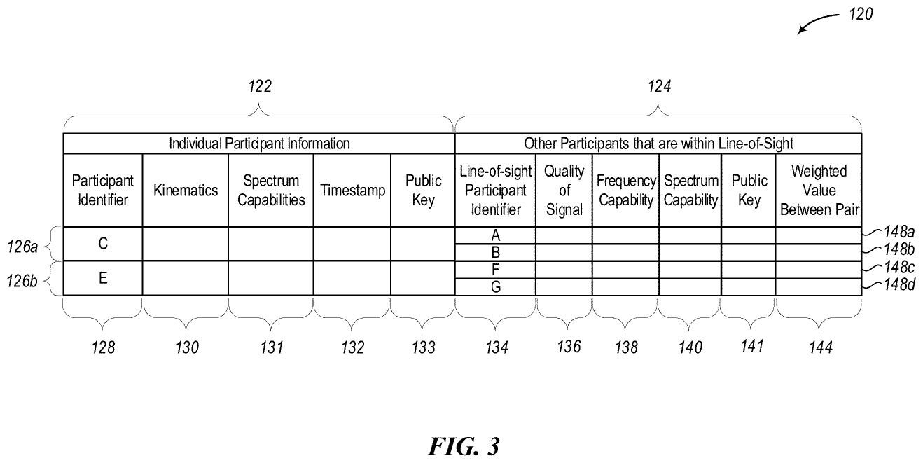

FIG. 5 is a data flow diagram showing how a node public key is changed in some embodiments as part of its transfer by the facility. The entire data flow 500 is divided into data flow 501 that occurs in a transferor node—such as node C; data flow from the transferor node to a transferee node—such as node H; and data flow 502 in the transferee node. In the transferor node, a local key generation operation 510 produces a key pair for the transferor node including both a public key 511 and a private key 512. The facility produces a token 521 from the public key. In various embodiments, the facility produces the token by copying the public key, or by performing a securing or obfuscating transformation on the public key as described elsewhere herein. The facility splits the token into two portions: portion a 531 and portion b 532. The facility transmits portions a and b from the transferor node to the transferee node separately. In the transferee node, the facility combines portions a and b in a manner inverse to their creation, as described elsewhere herein. The facility produces the transferor public key from the token. If the token was created in the transferor by performing a transformation to the public key, the facility reverses this transformation in the transferee to obtain the transferor public key, as described elsewhere herein.

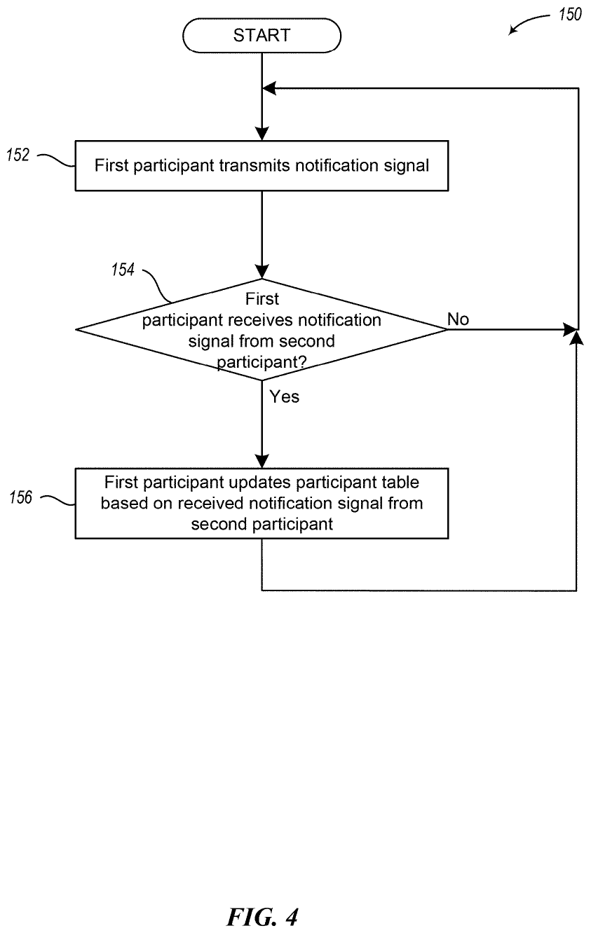

FIG. 6 is a data flow diagram showing a typical exchange of messages by which the facility transfers a node public key in some embodiments. The entire flow 600 is made up of the exchange of messages 610, 620, and 630 between transferor node C 601 and transferee node H 602. First, node C broadcasts a notification signal 610. The notification signal contains portion a 611 of node C's public key token as node C's node ID. In response to receiving the notification signal and determining that node H is not presently connected to node C, node H directs a connection request 620 to node C. In some embodiments, directing the connection request to node C involves including node C's node ID—portion a of its public key token—in the connection request as the connection request's addressee node (not shown). In some embodiments, the connection request includes a node ID 621 for node H formed as portion a of node H's public key token. In response to receiving the connection request, node C directs to node H a handshake message 630 containing portion b 631 of node C's public key token.

In some embodiments, it is typical for transfer of a first node's public key to a second node to be contemporaneous with transfer of the second node's public key to the first node. In some such embodiments, the facility performs the transfer of node H's public key to node C as shown in FIG. 6, with the identity of the two nodes reversed—that is, this transfer is initiated by node H's broadcast of its own notification signal. In some such embodiments, the facility performs the transfer of node H's public key to node C in a manner directly responsive to the transfer of node C's public key to node H: in response to receiving node H's connection request 620 containing portion a of node H's public key token, in addition to sending handshake 630 to node H, node C also sends its own connection request to node H (not shown); in response to receiving node C's connection request, node H sends node C a handshake message containing portion b of node H's public key token (not shown).

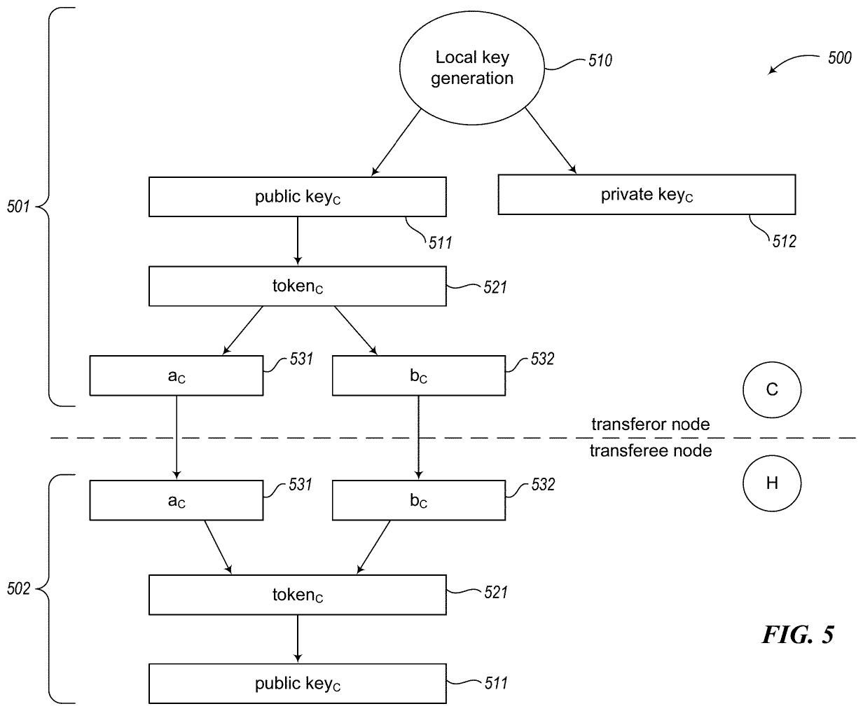

FIG. 7 is a flow diagram showing a process performed by the facility in some embodiments in a transferor node to send a first portion of the transferor node's public key data to one or more transferee nodes. In act 701, the facility performs local generation of a public/private key pair to be used by the transferor node. In various embodiments, the facility generates this key pair using various techniques. In some embodiments, the facility generates the key pair as described in Public-Key Cryptography Standards (PKCS) #1: RSA Cryptography Specifications Version 2.1, RFC 3447, available at datatracker.ietf.org/doc/html/rfc3447, which is hereby incorporated by reference in its entirety. In cases where particular contents of a document incorporated herein by reference conflict with the present patent application, the present application controls. In some embodiments, the facility generates the key pair as described in The Exponential Security System TESS: An Identity-Based Cryptographic Protocol for Authenticated Key-Exchange, RFC 1824, available at datatracker.ietf.org/doc/html/rfc1824; and Fundamental Elliptic Curve Cryptography Algorithms, RFC 6090, available at datatracker.ietf.org/doc/html/rfc6090; both of which are hereby incorporated by reference in their entirety.

In act 702, the facility transforms the public key into a token representation of the public key. In some embodiments, in act 702, the facility performs a null transformation by simply copying the public key to obtain the token. In some embodiments, the transformation performed in act 702 is an obfuscating or securing transformation. The token produced by the facility in act 702 is sometimes referred to herein as an “obfuscated public key.” In some embodiments, the transformation involves a shift rotation of the public key by a particular number of bits or bytes. In various embodiments, the number of bits or bytes is a fixed number known to all nodes authorized to participate in the network, or a variable number that can be determined by a process known to all nodes authorized to participate in the network, such as applying a particular modulo or other hashing algorithm to components of the current date and time. In some embodiments, the transformation involves encryption of the public key using a symmetric key or key pair known to all nodes authorized a participant in the network (a “global encryption key”). In some embodiments, the transformation involves applying the elliptic curve digital signature algorithm to use the public key to generate a signature for a fixed message known to all nodes authorized to participate in the network. This fixed message known to all nodes authorized to participate in the network is sometimes referred to as a “reference message.” The RFCs identified above provide details about these cryptographic operations.

In act 703, the facility separates the token into two segments or portions, a and b. In various embodiments, portions a and b are of equal size, or of unequal size. In various embodiments, the relative size of the portions is determined manually by an administrator, or automatically based upon such factors as the total size or space available in the two types of messages in which the portions are transmitted. In some embodiments, this separation involves selecting a certain number of highest-order bits of the token as portion a, and the remaining bits of the token as portion b. In some embodiments, the facility generates portions a and b using other techniques, such as by “unzipping” a different set of alternating bits or bytes from the token for each of the portions; this is sometimes described as traversing the bits of the token in order, assigning the bits visited in the traversal alternately to portions a and b. In some embodiments, both the public key and the token contain 256 bits, and the facility performs act 703 by selecting the highest-order 128 bits of the token as portion a, and the remainder of the token as portion b. Those skilled in the art will appreciate that the lengths of the public key, the token, and the portions can vary as needed.

In various embodiments, the two portions of the token do not overlap and are mutually exclusive portions of a single token. In other embodiments, the two portions partially overlap one another. The amount of overlap between the two portions may be set by an administrator, negotiated between nodes in the network, etc. In some embodiments, a third portion of the token is never transmitted from one node to another. For example, in some embodiments, the facility provides each node in the network a one- or two-bit third portion (or a third portion of some other size) for inclusion in all tokens. In various embodiments, the facility provides this third portion provided when a node initially registers with the network or receives its own public key to use in the network. This third portion may be at any positon in the token relative to portions a and b. As such, the node does not transmit this third portion of the token as part of portion a or portion b. The recipient node is able to reconstruct the token based on portions a and b and the previously-provided third portion.

The length of the separate portions of the token may be set by an administrator, negotiated among nodes in a network or sub-network, selected based on the security requirements of the nodes of the network, or selected based on the type of nodes in the network. In some embodiments, portion a of the token is selected to replace the node identifier in a broadcasted message or notification signal sent by the node. In some embodiments, portion a is considered as that node's identifier to other nodes in the network. In some embodiments, portion a is included with each message transmitted by the node as that node's ID. When the node begins point-to-point communication with a specific node, as described herein, the node may include portion b of the token as the payload of one or more subsequent messages sent to the specific node to establish communications between the nodes.

In various embodiments, at least some part of portion a of the token, i.e., the portion acting as the node ID, may include data characteristics that are mathematically verifiable to valid nodes of the network. In this way, if a bad actor attempts to access the network, valid nodes in the network can identify the bad actor based on the bad actor's inability to provide a node ID that is mathematically verifiable by the nodes in the network. In some embodiments, this validation process is part of the token obfuscation process discussed herein.

In some embodiments (not shown), acts 702 and 703 are reversed, such that the facility performs separation before obfuscation. In some such embodiments, the facility obfuscates the two portions in different ways. In some such embodiments, the facility obfuscates one of the portions, but not the other.

In act 704, the facility broadcasts a notification signal from the transferor containing portion a of the token as the node ID of the transferor. After act 704, the facility continues in act 704 to periodically retransmit the notification signal. In some embodiments, certain fields or components of the notification signal can vary between transmission iterations, including a where the transferor has adopted a new key pair.

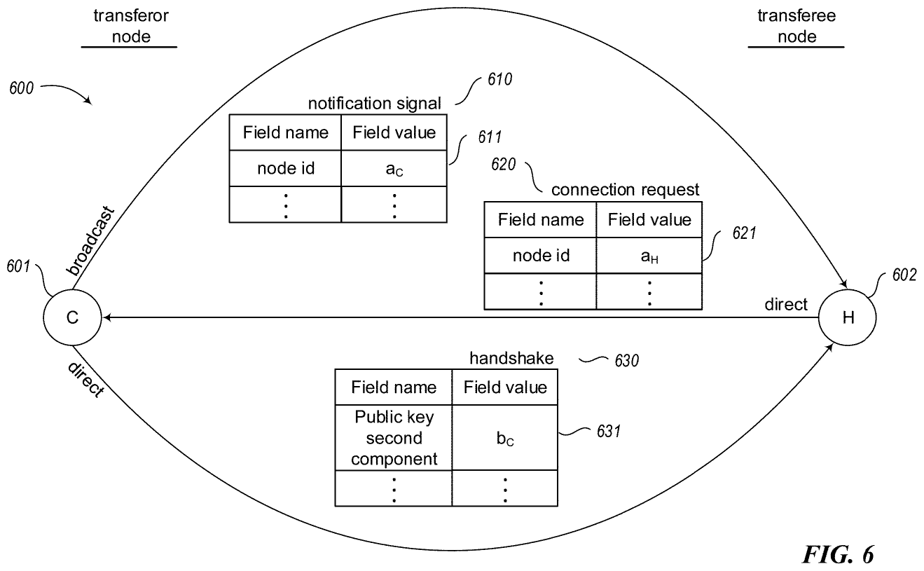

FIG. 8 is a flow diagram showing a process performed by the facility in some embodiments in a transferee node to receive a first portion of a transferor node's public key data. In act 801, the facility receives a notification broadcast by a transferor node in act 704 containing portion a of the transferor node's public key token as the node ID of the transferor node. In act 802, the facility sends a connection request to the transferor node. As noted above, in act 802, the facility may check whether the transferee node is already connected to the transferor node, and send the connection request only if such a connection is not already in place (not shown). After act 802, the facility continues in act 801.

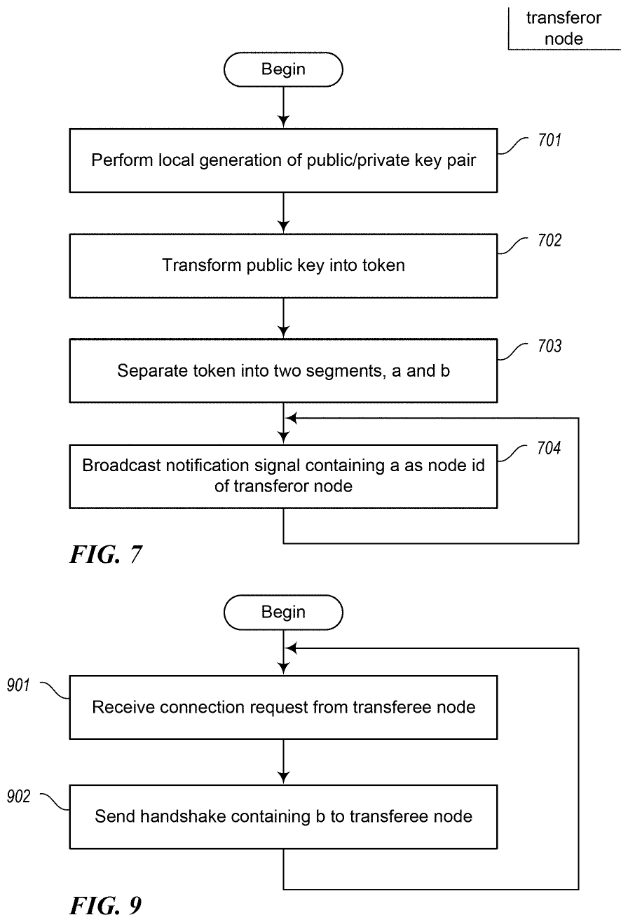

FIG. 9 is a flow diagram showing a process performed by the facility in some embodiments in the transferor node to send a second portion of the transferor node's public key data to the transferee. In act 901, the facility receives a connection request sent by the transferee node in act 802. In act 902, the facility sends a handshake message containing portion b of the transferor's public key token to the transferee node in response to the connection request. After act 902, the facility continues in act 901 to receive the next connection request from a transferee node.

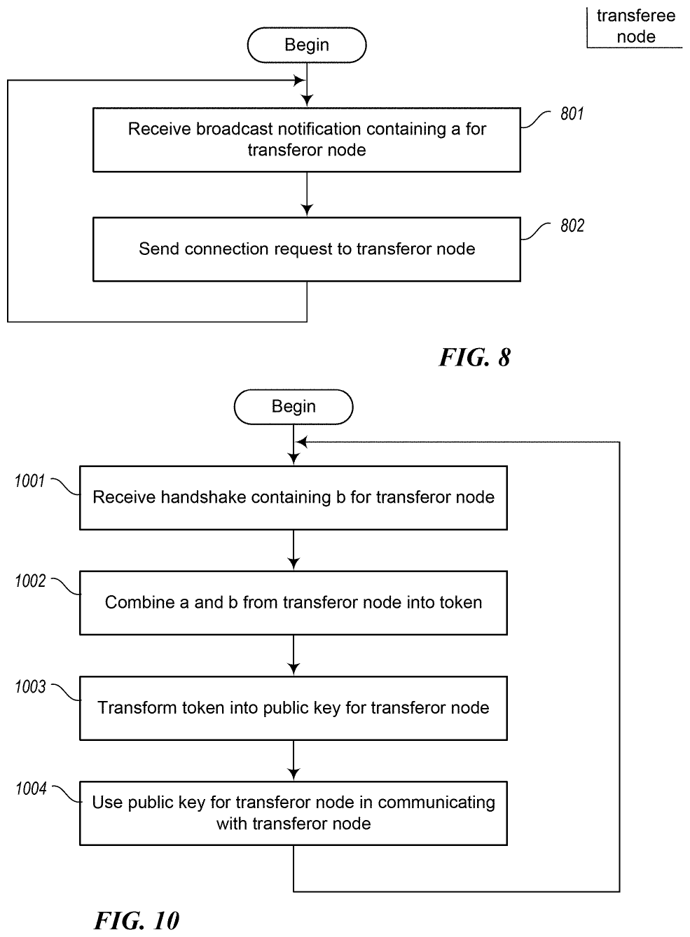

FIG. 10 is a flow diagram showing a process performed by the facility in some embodiments in the transferee node to receive a second portion of the transferor node's public key data and reconstitute the transferor node's public key. In act 1001, the facility receives a handshake message sent by the transferor in act 902 that contains portion b of the transferor's public key token. In act 1002, the facility combines portions a and b received from the transferor node in acts 801 in 1001. For example, if the token was split in the transferor to obtain the portions, the facility concatenates the portions in the transferee. If the portions were unzipped from the token in the transferor, the facility rezips the portions in the transferee.

In act 1003, the facility transforms the token obtained in act 1002 into the public key for the transferor node. For example, where the transformation from public key to token in the transferor node in act 702 was rotating the public key by a particular number of bits or bytes, act 1003 involves rotating the token by the same number of bits or bytes in the opposite direction. Where the transformation from public key to token was encrypting the public key using a symmetric key or key pair member, act 1003 involves decrypting the token using the symmetric key or other key pair member. Where the transformation from public key to token was applying ECDSA to generate a signature for a known fixed message with the public key, act 1003 involves applying an ECDSA public key recovery process to the token as signature and the known fixed message to recover the public key. Details of this public key recovery process are provided in SECG SEC 1: Elliptic Curve Cryptography (Version 2.0), section 4.1.6, available at www.secg.org/sec1-v2.pdf; and Elliptic Curve Digital Signature Algorithm, section 4, Wikipedia, available at en.wikipedia.org/wiki/Elliptic_Curve_Digital_Signature_Algorithm#Public_key_reco very; both of which are hereby incorporated by reference in their entirety.

In some embodiments (not shown), after act 1003, the facility validates the token. In various embodiments, this validation includes bit count validation, checksum validation, signature verification, etc.

In act 1004, the facility uses the public key for the transferor node obtained in act 1003 for communicating with the transferor node. In some embodiments, act 1004 involves storing the obtained public key in column 133 and/or column 141 of participant table 120 shown in FIG. 3 for the transferor node. In some embodiments, act 1004 involves using the obtained public key to encrypt communications intended for the transferor, such that they can only be decrypted with the transferor's private key. In some embodiments, act 1004 involves using the obtained public key to verify signatures on messages formed using the transferor's private key. In some embodiments, act 1004 involves two nodes using the public keys obtained from one another to negotiate a symmetric session key used by both nodes to encrypt future communication between the two nodes. In some embodiments, the facility generates such a session key as described in S. L. Graham, R. L. Rivest, and Ralph C. Merkle, Secure Communications Over Insecure Channels, available at citeseerx.ist.psu.edu/viewdoc/summary?doi=10.1.1.364.5157; and Diffie-Hellman key exchange, Wikipedia, available at en.wikipedia.org/wiki/Diffie % E2%80%93Hellman_key_exchange; both of which are hereby incorporated by reference in their entirety.

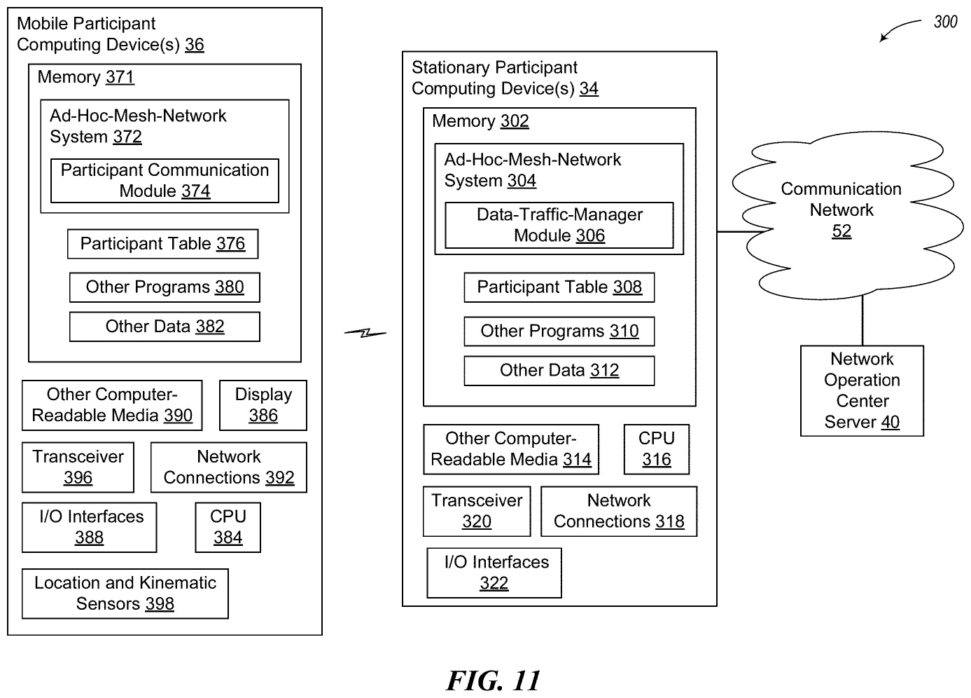

FIG. 11 shows a system diagram that describes one implementation of computing systems for implementing embodiments described herein. System 300 includes mobile participant computing device(s) 36, stationary participant computing device(s) 34, and network operation center server 40.

Mobile participant computing device(s) 36 communicate with one or more other mobile participant computing devices 36 and stationary participant computing devices 34 via line-of-sight communications to transmit data and other communications among the participants. One or more special-purpose computing systems may be used to implement each mobile participant computing device 36. Accordingly, various embodiments described herein may be implemented in software, hardware, firmware, or in some combination thereof. A mobile participant computing device 34 may include memory 371, one or more central processing units (CPUs) 384, display 386, I/O interfaces 388, other computer-readable media 390, network connections 392, transceiver 396, and motion sensors or other sensors 398.

Memory 371 may include one or more various types of non-volatile and/or volatile storage technologies. Examples of memory 371 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 371 may be utilized to store information, including computer-readable instructions that are utilized by CPU 384 to perform actions, including embodiments described herein.

Memory 371 may have stored thereon ad-hoc-mesh-network system 372, which includes participant communication module 374. The participant communication module 374 may employ embodiments described herein to send notification signals, track participants via participant table 376, and to generate and transfer data and communications to other participants.

The memory 371 also stores participant table 376. In various embodiments, this is a local version of the participant table generated by the mobile participant or received from a stationary participant 34 or other mobile participant 36. The participant table 376 may be a partial version or a complete version of the participant table 308 maintained by the stationary participants 34 or by mobile participants if stationary participants are unavailable.

The memory 371 may also store other programs 380 and other data 382. The other programs 380 may include user applications, other tracking or geo-positioning programs, etc. The other data 382 may include data or information regarding one or more non-participant objects or other information.

Network connections 392 are configured to communicate with other computing devices, such as other mobile participant computing devices 36 and stationary participant computing devices 34 via transceiver 396 and line-of-sight communications mechanisms and technologies. Transceiver 396 may be a omni-directional transceiver that sends and receives radio signals independent of direction, or transceiver 396 may be a directional transceiver that sends or receives, or both sends and receives, radio signals to or from a particular direction relative to the positioning of the mobile participant computing device 36.

Location and kinematic sensors 398 include one or more sensors that are used to determine the position of the mobile participant computing device 36 and the kinematic information of how the mobile participant computing device 36 is moving. Examples of location and kinematic data sensors 398 include, but are not limited to using participant's self-reported notifications calibrated off of stationary participants, processing the echo of own self-reported notifications, GPS modules, accelerometers, gyroscopes, or other sensors that can be used to determine the position and kinematic information of the mobile participant computing device 36.

Other I/O interfaces 322 may include a keyboard, audio interfaces, video interfaces, or the like. Other computer-readable media 390 may include other types of stationary or removable computer-readable media, such as removable flash drives, external hard drives, or the like. Display 386 is a display interface that is configured to output images, content, or information to a user. Examples of display 386 include, but are not limited to, LCD screens, LEDs or other lights, or other types of display devices.

Stationary participant computing device(s) 34 communicate with mobile participant computing devices 36 via line-of-sight communications and with other stationary participants either by wired or wireless communications to transmit information or data to other participants or to non-participants. One or more special-purpose computing systems may be used to implement each stationary participant computing device 34. Accordingly, various embodiments described herein may be implemented in software, hardware, firmware, or in some combination thereof. A stationary participant computing device 34 may include memory 302, one or more central processing units (CPUs) 316, I/O interfaces 322, other computer-readable media 314, network connections 318, and transceiver 320.

Memory 302 may include one or more various types of non-volatile and/or volatile storage technologies. Examples of memory 302 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 302 may be utilized to store information, including computer-readable instructions that are utilized by CPU 316 to perform actions, including embodiments described herein.

Memory 302 may have stored thereon ad-hoc-mesh-network system 304, which includes data-traffic-manager module 306. The data-traffic-manager module 306 may employ embodiments described herein to transfer data from one participant to another participant and to manage and provide participant table updates. In various embodiments, data-traffic-manager module 306 may communicate with network operation center server 40 via communication network 52, such as to provide or receive participant table updates.

The memory 302 may also store participant table 308, other programs 310, and other data 312. The participant table 308 may be a full version of the participant table 308 or it may be a partial version based on those mobile participants 36 within line-of-sight of or a threshold number of hops from the stationary participant 34. The other data 312 may include data or information regarding one or more tracked objects or other information.

Network connections 318 are configured to communicate with other computing devices, such as other stationary participant computing devices 34 and mobile participant computing devices 36 via transceiver 320 and wired or line-of-sight communications mechanisms and technologies. Network connections 318 are also configured to communicate with the network operation center server 40 via communication network 52.

Transceiver 320 may be a omni-directional transceiver that sends and receives radio signals independent of direction, or transceiver 320 may be a directional transceiver that sends or receives, or both sends and receives, radio signals to or from a particular direction relative to the position of the stationary participant computing device 34.

Other I/O interfaces 322 may include a keyboard, audio interfaces, video interfaces, or the like. Other computer-readable media 314 may include other types of stationary or removable computer-readable media, such as removable flash drives, external hard drives, or the like.

Network operation center server 40 includes one or more computing devices that store information about the positioning of mobile participant computing devices 36 and stationary participant computing devices 34, such as a master participant table. The network operation center server 40 may also store information regarding the positioning and movement of non-participant objects that are reported to it by the mobile participant computing devices 36 or the stationary participant computing devices 34. The network operation center server 40 also includes memory, one or more processors, network interfaces and connections, and other computing components similar to mobile participant computing devices 36 and stationary participant computing devices 34, but those components are not shown here for ease of illustration.

Communication network 52 may include one or more wired or wireless communication networks to transmit data between one stationary participant computing device 34 and another stationary participant computing device 34 or with the network operation center server 40.

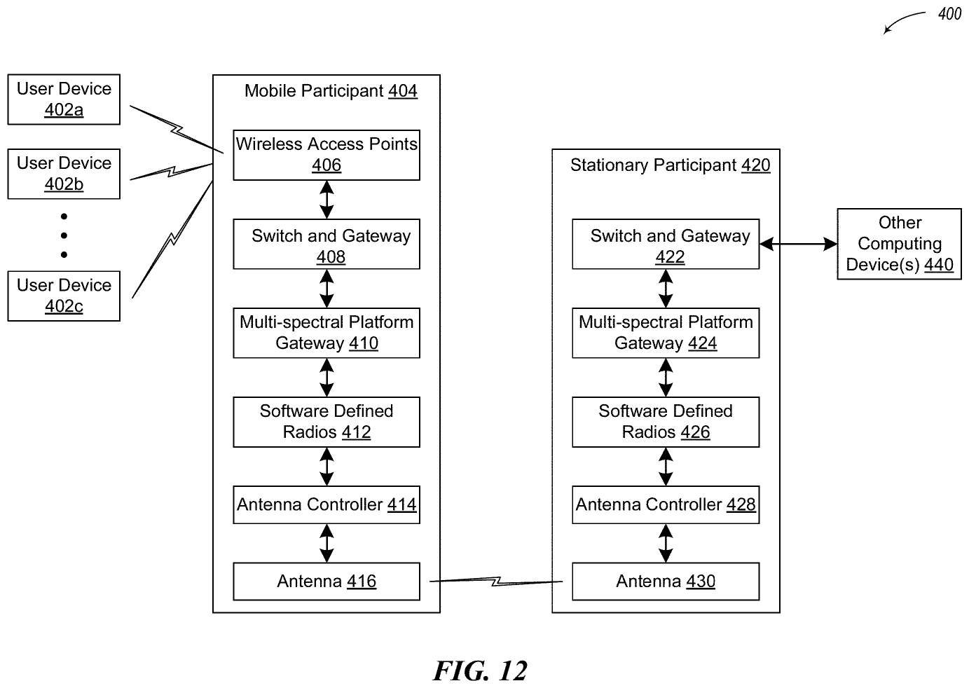

FIG. 12 shows a system diagram that describes another implementation of computing systems for implementing embodiments described herein. System 400 includes user devices 402a-402c that are in wireless line-of-sight communication with mobile participant 404, which is in wireless line-of-sight communication with stationary participant 420, which is in wired communication with other computing device 440. As described above, user devices 402a-402c may be tier 1 mobile participants in communication with a tier 3 mobile participant or some other mobile participant. Mobile participant 404 may be an embodiment of a mobile participant 32 and stationary participant 420 may be an embodiment of a stationary participant 34 discussed above.

Mobile participant 404 includes one or more wireless access points 406 to communicate with user devices 402a-402c. Switch and gateway 408 coordinates and handles communications between the wireless access points 406 and a multi-spectral platform gateway 410. The multi-spectral platform gateway 410 performs embodiments described herein to update the participant table and to select an optimum route, spectrum and antenna to transmit communications from the mobile participant 404. The multi-spectral platform gateway 410 also selects many transmission characteristics based on information in the participant table and provides them to one or more software defined radios 412. The software defined radios 412 select the frequency from the multi-spectral platform gateway selected spectrum at which to transmit communication from the mobile participant 404. The antenna controller 414 form and steer a transmission beam via antenna 430 based on the selected transmission information, the selected frequency, and the multi-spectral platform gateway provided location of intended recipient. This transmission may be directed to another mobile participant 404, another type of mobile participant, or to the stationary participant 420.

In some embodiments, the mobile participant 404 may store or cache a threshold amount of data received from or provided to the user devices 402a-402c. The data may be cached for a threshold amount of time or storage space. In this way, if a user device subsequently requests the same data that was already obtained for another user device, such as a movie or other in-flight entertainment, then the mobile participant 404 can provide the cached data to the user device without having to transmit additional communications to other participants to obtain the data. In some embodiments, forwarding participants may also cache data for a predetermined amount of time, which can act as a backup incase the forwarded communication was not successfully received or if the forwarding participant has to select another route to transmit the communication. In yet other embodiments, the cached data can be used to answer a request from another participant so that they do not have to request the information from a stationary participant, which can alleviate wasted network usage by transferring data that has already been transferred from the internet or other source previously.

Stationary participant 420 receives the transmission from the mobile participant 404 at an antenna controller 428 via antenna 430 and provides the received signals to a software defined radio 426. The software defined radio 426 provides the received communications to a multi-spectral platform gateway 424, which determines whether the communication should be transmitted to a next participant, such as another mobile participant 404, some other mobile participant, or to another stationary participant 420 via a wired network, or whether the communication is to be provided to other computing devices 440. If the communication is to be transmitted to another mobile participant or another mobile participant via line-of-sight communications, then the stationary participant 420 utilizes the multi-spectral platform gateway 424, the software defined radios 426, the antenna controller 428, and the antenna 430 in a manner similar to mobile participant 404 to directionally transmit the communication to a next participant. If the communication is destined for some other non-participant computing device, then the multi-spectral platform gateway 424 provides the communication to switch and gateway 422 for transmission via a wired communication network to other computing devices 440.

If the communication was for data or information from the other computing devices 440, then the other computing devices 440 may answer a request and return data or information to the stationary participant 420 for transmission to the mobile participant 404 and then to the requesting user device 402 in a somewhat reverse fashion than what is described above.

One non-limiting non-exhaustive example of components utilized by the mobile participant 404 may include, but is not limited to: a conformal and non-conformal electronically steered antenna array, cabling appropriate for array and radio communication, cognitive radio suites that both receive and transmit in pairs suitable to service the entirety of the participant max capacity, cabling appropriate for radio to host platform communication, cabling from host platform to server and in-flight entertainment suite, onboard server with up to 10 TB of storage, onboard cognitive modems and routers with public address capability, cognitive equipment power supplies, cognitive radio transmission amplifier and power supply, and onboard firewall.

One non-limiting non-exhaustive example of components utilized by the mobile participant 404 may include, but is not limited to: an adaptive power backup generator, cognitive multi-spectral antennas×6, 42U rack, rack mounted server, integrated processor chip, SSL & VPN appliance, external firewall appliance, internal firewall appliance, load management appliance, web filter appliance, multi-spectral cognitive Radio×4, High throughput router, smart power strip/UPS, mesh network Wi-Fi appliances, small mesh network home appliances, wireless access points with public address appliances, and backhaul connectivity.

In various embodiments, communications between participants may include one or multi-level security. For example, in some embodiments, all transmission via the participant network may employ a first encryption or security mechanism. Some communications between participants may further include another layer of security. For example, a user may have a cell phone and a home network. The cell phone may be a mobile participant and a router on the home network may be a participant access node. The home network may be protected by Wired Equivalent Privacy (WEP), Wi-Fi Protected Access (WPA), Wi-Fi Protected Access II (WPA2), or other security mechanism. In this example, the cell phone participant may first encrypt communications via the same security mechanism as the home network and then encrypt the communications using the network encryption. The cell phone participant employs embodiments described herein to route the encrypted communications to the router participant, which can decrypt the communication using the network encryption mechanism and then the home network security mechanism. Even additional layers of encryption and security can be employed for a group of users or devices, subsets of users in the group, individuals in those subsets, etc.

The various embodiments described above can be combined to provide further embodiments. These and other changes can be made to the embodiments in light of the above-detailed description. Moreover, additional details and use case examples are provided in the U.S. patents, U.S. patent application publications, U.S. patent applications, foreign patents, foreign patent applications and non-patent publications referred to in this specification and/or listed in the Application Data Sheet, including but not limited to U.S. patent application Ser. No. 15/892,259, filed Feb. 8, 2018, entitled “Object Tracking Using A Cognitive Heterogeneous Ad Hoc Mesh Network” and Provisional Patent Application No. 62/467,572, filed Mar. 6, 2017, entitled “Scatternet: A cognitive heterogeneous ad hoc mesh data/cellular/Wi-Fi network establishment/access points/connected devices through utilization of software applications exploiting existing technologies and frequency spectrum for data and voice communications through the exploitation of the Internet and Internet of Things, resulting in the creation of Data communications Adaptive RADAR (DATAR),” are incorporated herein by reference, in their entirety.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing device, comprising:
generating a key pair including a private key and a public key for use by a first mobile communication device in communicating with other mobile communication devices, the public key having information content;
constructing a first public key component and a second public key component, the first public key component and the second public key component each encoding an incomplete portion of the information content of the public key, the first public key component and the second public key component collectively encoding the complete information content of the public key; and
transmitting a first wireless message for receipt by other mobile communication devices, the first wireless message having first contents that identify the first wireless message as a notification signal, the first wireless message having as second contents the first public key component, the second contents being located at a position in the first wireless message that identifies the second contents as of the first mobile communication device's node ID.

2. The method of claim 1, further comprising:
after transmitting the first wireless message, receiving a second wireless message, the second wireless message having first contents that identify the second wireless message as a connection request, the second wireless message having second contents identifying a second mobile communication device that transmitted the second wireless message; and
in response to receiving the second wireless message, transmitting a third wireless message addressed to the identified second mobile communication device, the third wireless message having first contents that identify the third wireless message as a handshake message, the third wireless message having as second contents the second public key component.

3. The method of claim 2, further comprising, in the second mobile communication device:
receiving the first and third wireless messages;
constructing the public key from the first and second public key components; and
using the constructed public key to communicate with the first mobile communication device.

4. The method of claim 1, further comprising:
performing an obfuscating transformation on the public key to obtain an obfuscated public key,
and wherein the first and second public key components are constructed from the obfuscated public key.

5. The method of claim 4 wherein performing the obfuscating transformation comprises using the private key to sign a reference message, the reference message being stored by at least two mobile communication devices that include the first mobile communication device.

6. The method of claim 4 wherein performing the obfuscating transformation comprises encrypting the public key using a global encryption key, the global encryption key being stored by at least two mobile communication devices that include the first mobile communication device.

7. The method of claim 4 wherein the obfuscated public key is comprised of a number of ordered bits,
and wherein constructing the first public key component comprises extracting the highest-order half of the obfuscated public key's bits,
and wherein constructing the second public key component comprises extracting the lowest half of the obfuscated public key's bits.

8. The method of claim 4 wherein the obfuscated public key is comprised of a number of ordered bits,
and wherein constructing the first and second public key components comprises traversing the bits of the obfuscated public key in order, assigning the bits visited in the traversal alternately to the first public key component and the second public key component.

9. The method of claim 1, further comprising:
receiving a second wireless message transmitted by a second mobile communication device;
determining that contents of the second wireless message identify the second wireless message as a notification signal;
in response to determining that contents of the second wireless message identify the second wireless message as a notification signal:
extracting contents of the second wireless message from a position in the second wireless message corresponding to a node ID of a sender of the notification signal;
transmitting a third wireless message addressed to the second mobile communication device, the third wireless message having contents identifying the third wireless message as a connection request;
after transmitting the third wireless message, receiving a fourth wireless message transmitted by the second mobile communication device;
determining that contents of the fourth wireless message identify the fourth wireless message as a handshake message;
in response to determining that contents of the fourth wireless message identify the fourth wireless message as a handshake message, extracting contents of the fourth wireless message; and
using the extracted contents of the second and fourth wireless messages to construct a public key used by the second mobile communication device.

10. One or more memories collectively having contents configured to cause a first mobile communication device to perform a method, the method comprising:
receiving a first wireless message transmitted by a second mobile communication device;
determining that contents of the first wireless message identify the first wireless message as a notification signal;
in response to determining that contents of the first wireless message identify the first wireless message as a notification signal:
extracting contents of the first wireless message from a position in the first wireless message corresponding to a node ID of a sender of the first wireless message;
transmitting a second wireless message addressed to the second mobile communication device having as its node ID the contents extracted from the first wireless message, the second wireless message having contents identifying the second wireless message as a connection request; and
after transmitting the second wireless message, receiving a third wireless message transmitted by the second mobile communication device.

11. The one or more memories of claim 10, the method further comprising:
determining that contents of the third wireless message identify the third wireless message as a handshake message;
in response to determining that contents of the third wireless message identify the third wireless message as a handshake message:
extracting contents of the third wireless message; and
using the contents extracted from the first and third wireless messages to construct a public key used by the second mobile communication device.

12. The one or more memories of claim 11, wherein the constructing comprises:
combining the contents extracted from the first and third wireless messages to obtain a token; and
performing an obfuscation reversal operation against the token to obtain the constructed public key used by the second mobile communication device.

13. The one or more memories of claim 12 wherein performing the obfuscation reversal operation comprises performing a public key recovery technique against (1) the token and (2) a reference message stored by both the first and second mobile communication devices, the reference message having been signed by the second communication device with a private key corresponding to the public key used by the second communication device to produce the token.

14. The one or more memories of claim 12 wherein performing the obfuscation reversal operation comprises decrypting the token using a token decryption key stored by both the first and second mobile communication devices.

15. The one or more memories of claim 12, the method further comprising using the constructed public key in communicating with the second mobile communication device.

16. The one or more memories of claim 15, the method further comprising elevating the constructed public key to determine whether it is a proper public key for the second mobile communication device,
and wherein using the constructed public key in communicating with the second mobile communication device is performed only in response to determining that the constructed public key is a proper public key for the second mobile communication device.

17. The one or more memories of claim 12 wherein using the constructed public key in communicating with the second mobile communication device comprises using the constructed public key to negotiate with the second mobile communication device a session key usable to encrypt communications between the first and second mobile communication devices.

18. The one or more memories of claim 12 wherein using the constructed public key in communicating with the second mobile communication device comprises either or both of:
using the constructed public key to decrypt a message sent by the second mobile communication device that has been encrypted with a private key used by the second mobile communication device that corresponds to the constructed public key; or
using the constructed public key to verify a signature on a message sent by the second mobile communication device, the signature having been formed using the private key used by the second mobile communication device.

19. The one or more memories of claim 12, the method further comprising using the constructed public key in communicating with the second mobile communication device in an ad hoc mesh wireless network.

20. The one or more memories of claim 12, the method further comprising storing the constructed public key in an entry of a participant table maintained by the first mobile communication device that corresponds to the second mobile communication device.

21. A first mobile communication device, the first mobile communication device having a memory that stores a private key and a public key, a radio transmitter being installed in the first mobile communication device that transmits a first data structure, the first data structure comprising:
first data identifying the first data structure as constituting a notification signal; and
second data occupying a position in the first data structure corresponding to sender mobile communication device ID, the second data encoding a first incomplete portion of the information content of the first mobile communication device's public key, such that the second data is usable by a second mobile communication device that (1) receives the first data structure transmitted by the radio transmitter and (2) separately receives third data encoding a second incomplete portion of the information content of the first mobile communication device's public key—the second and third data collectively encoding complete information content of the first mobile communication device's public key—to reconstitute the first mobile communication device's public key.

22. The first mobile communication device of claim 21, the radio transmitter further transmitting a second data structure separately from the first data structure, the handshake message data structure comprising
fourth data identifying the second data structure as constituting a handshake message; and
the third data.

23. The first mobile communication device of claim 22 wherein the second data and the third data collectively constitute a signature on a reference message stored by both the first mobile communication device and the second mobile communication device made with the private key of the first mobile communication device,
such that the second data, the third data, and the reference message are usable by the second mobile communication device to recover the first mobile communication device's public key.
